(19) United States
(12) Patent Application Publication
(10) Pub. No.: US 2014/0097127 A1
(43) Pub. Date: Apr. 10, 2014

(54) Screening Apparatus

(71) Applicants: Barry Aughey, County Monaghan (IE); Eric O'keeffe, County Monaghan (IE)

(72) Inventors: Barry Aughey, County Monaghan (IE); Eric O'keeffe, County Monaghan (IE)

(73) Assignee: AUGHEY RESEARCH AND DESIGNS LIMITED, County Monaghan (IE)

(21) Appl. No.: 14/100,792

(22) Filed: Dec. 9, 2013

Related U.S. Application Data
(63) Continuation of application No. 12/282,539, filed on Sep. 11, 2008, now abandoned.

(30) Foreign Application Priority Data
Mar. 14, 2006 (IE) S2006/0198

(51) Int. Cl. B07B 1/28

(52) U.S. Cl. CPC B07B 1/28
USPC 209/365.1

(57) ABSTRACT

A screening apparatus having a screening box movably mounted on a support member (22) via biasing members (23), the screening box having a pair of opposing side walls (14,15) and a vibrating arrangement (100) for vibrating the screening box relative to the support member (22). The vibrating arrangement (100) comprising a shaft housing member (42) for housing at least one rotatable shaft (1,2,3,) and shaft coupling members (41) for coupling the shaft housing member (42) to the opposing side walls (14,15) of the screening box. A shaft (1,2,3) is rotatably housed in the shaft housing member (42). The vibrating arrangement (100) further comprising a throw generating assembly (53) rotatably mounted on both ends of the shaft housing member (42). The throw generating assembly (53) is releasably fixed to the shaft (1,2,3). A drive arrangement is also provided comprising a motor (60), shaft driver members (4,5,6) on one end of the shaft (1,2,3) and a flexible endless drive member (7) coupled between the motor (60) and the shaft driver members (4,5,6). Each throw generating assembly (53) is rotatable about the shaft housing member (42) via the drive arrangement and shaft (1,2,3) to impart vibratory movement to the screening box.

The invention relates to a screening apparatus having a vibrating assembly. In particular, the invention relates to a screening apparatus with a vibrating shaft assembly for use in a horizontal screening apparatus.

It is an object of the present invention to provide an improved screening apparatus having a vibrating assembly which does not require complex machined parts and gearing systems.

Accordingly, the present invention provides a screening apparatus having a screening box movably mounted on a support means via biasing means, the screening box comprising a pair of opposing side walls and a vibrating means for vibrating the screening box relative to the support means, the vibrating means comprising means for housing at least one rotatable shaft and means for coupling the shaft housing means to the opposing side wails of the screening box, a shaft rotatably housed in the at least one shaft housing means, the vibrating means further comprising throw generating means rotatably mounted on both ends of the at least one shaft housing means, the throw generating means being releasably fixed to the at least one shaft, drive means comprising a motor, shaft driver means on one end of the at least one shaft and a flexible endless drive member coupled between the motor and the shaft driver means, each throw generating means being rotatable about the shaft housing means via the drive means and shaft to impart vibratory movement to the screening box.

Preferably, the vibrating assembly has a plurality of shafts, each having a shaft driver means wherein the flexible endless drive member positively engages the motor and the shaft driver means of each shaft.

Ideally, the vibrating assembly has three shafts.

Preferably, the shafts are mounted on the screen box at substantially the same vertical height.

Ideally, the motor is located above the one or more shafts.

Ideally, the motor has a drive member.

Preferably, the flexible endless drive member is arranged over the shaft driver means of the three shafts and the drive member of the flintier so that the end shafts turn in a clockwise direction and the middle shaft turns in an anti-clockwise direction giving the vibration assembly an oval vibration action.

Ideally, a portion of the flexible endless drive member between the drive member of the motor and one end shaft driver means is inclined at approximately the same angle as the angle of vibration of the screening box.

Preferably, each shaft driver means is a pulley,

Ideally, the drive member of the motor is a pulley.

Preferably, the flexible endless drive member Is a belt.

Ideally, each throw generating means is a hub lock assembly,

Ideally, each hub lock assembly comprises a self aligning bearing and a counterweight.

Preferably, each hub lock assembly further comprises a tapered adapter sleeve mounted intermediate the shaft housing means and the self aligning bearing.

Ideally, the counterweight has two component parts movable relative to one another for modifying the angle and stroke of vibration of the screening box.

Preferably, the two component part counterweight has a first part comprising a cylindrical hub portion and a counter-weight portion and a second part comprising a counter-weight engaging over the cylindrical hub portion and against the counter-weight portion.

Ideally, the counter-weight portion and the counter-weight each define a number of bolt receiving bores which are in alignment at particular relative angular positions of the counter-weight portion and the counter-weight.

Preferably, bolts are located in the bolt receiving bores which are in alignment to fix the counter-weight portion and the counter-weight at particular relative angular positions.

Ideally, the cylindrical hub portion houses the self aligning bearing.

Preferably, the counterweight has a plurality of holes for receiving plug weights.

Ideally, the shaft coupling means are secured towards the ends of the shaft housing means by forming complementary screw threads on the shaft coupling means and the shaft housing means.

Preferably, the belt is double sided and has equally spaced teeth on both sides.

Ideally, the hub lock assembly and the flexible endless drive member are housed in separate compartments.

Ideally, sealing means are provided to prevent the Ingress of foreign particles Into the flexible endless drive member compartment and the throw generating means compartment.

Preferably, sealing means is provided between the compartments to prevent oil leaking into the flexible endless drive member compartment from the hub lock assemblies.

Conveniently, the drive pulley includes a taper lock.

Conveniently, the timing belt is arranged to minimize belt flapping.

The present invention has a number of advantages over vibrating assemblies known in the art. Commonly, hubs or shaft coupling members are provided as an integral part of the shaft housing assembly as a flanged construction and require machining to ensure alignment. By utilizing the hubs/shaft coupling members of the present invention, a vibrating assembly of any width can be made using the same hubs/shaft coupling members. The hubs/shaft coupling members are inserted onto shaft housings of the required length and secured thereto. As the parts used at either end of the shafts are the same, construction is simplified and parts are easily serviceable. The hubs/shaft coupling members self align when inserted onto the shaft housing and provide added structural strength to the assembly. Using the hubs/shaft coupling members provided by the present assembly ensures the vibrating load is transmitted to the backing plate of the assembly housing and then transferred to the screening decks and spread over a large area.

The invention will now be described with reference to the accompanying drawings which show, by way of example only, two embodiments of a vibrating assembly according to the invention. In the drawings:

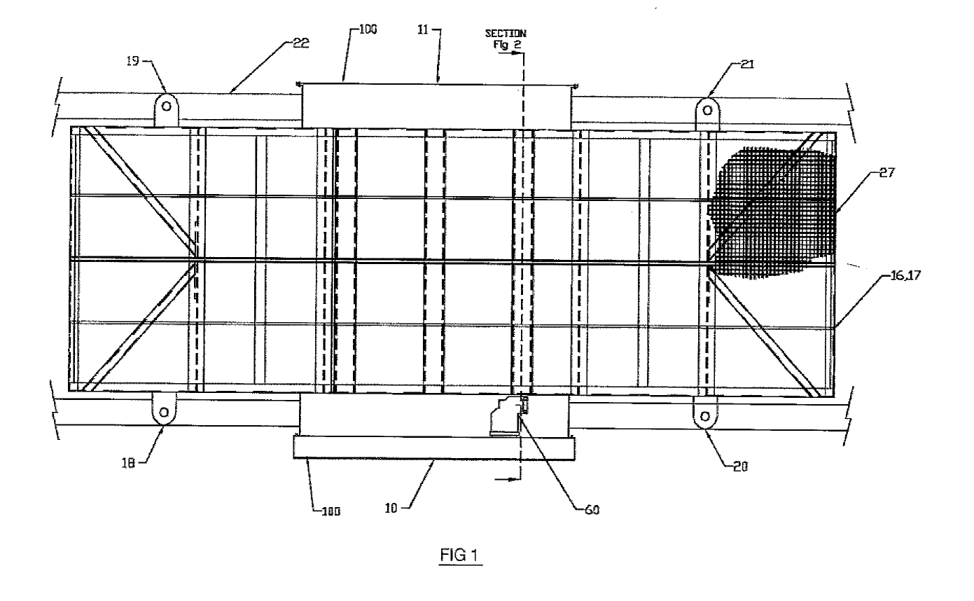

FIG. 1 is a plan view of a screening apparatus incorporating a vibrating assembly according to a first embodiment of the invention;

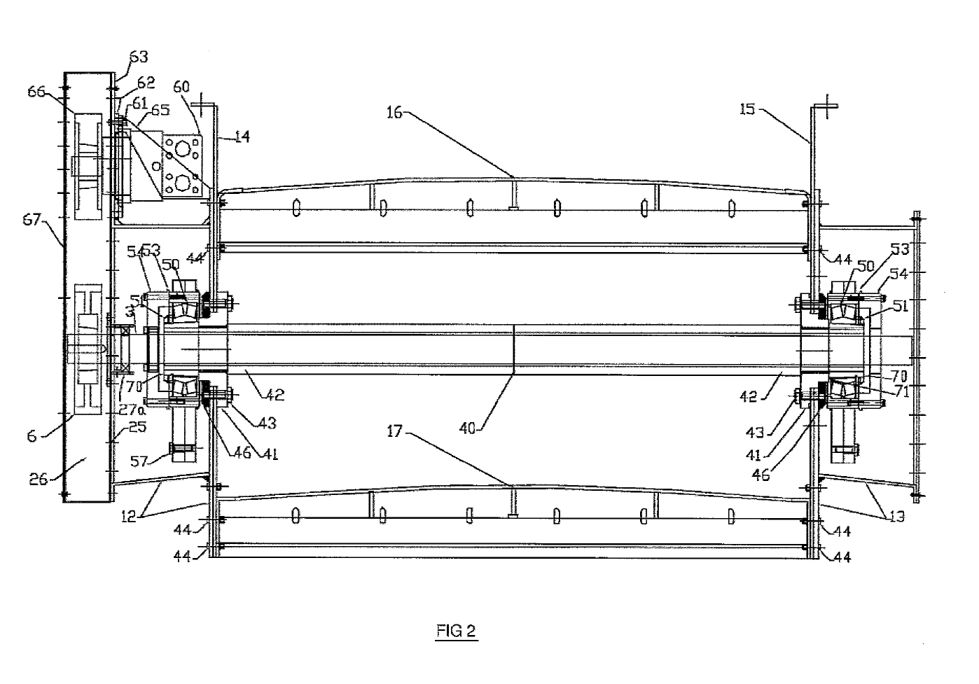

FIG. 2 is a cross-sectional end view of the apparatus of FIG. 1;

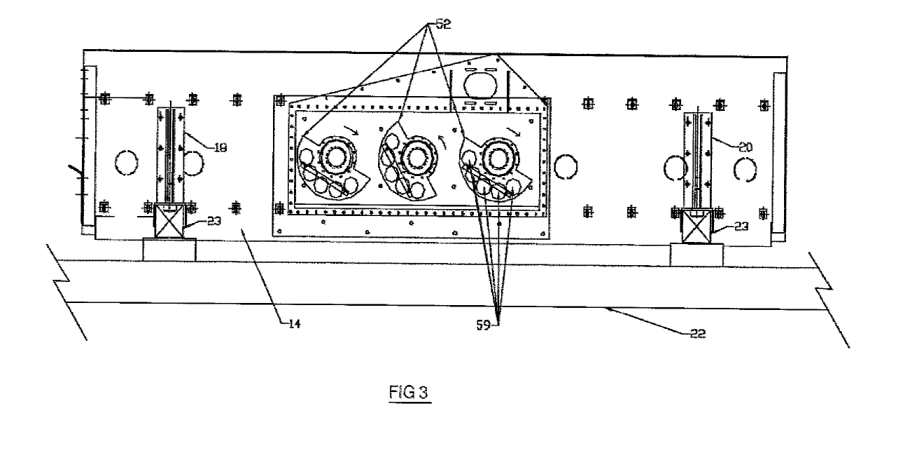

FIG. 3 is a side view of the apparatus of FIG. 1 with the main housing cover of the vibrating assembly removed;

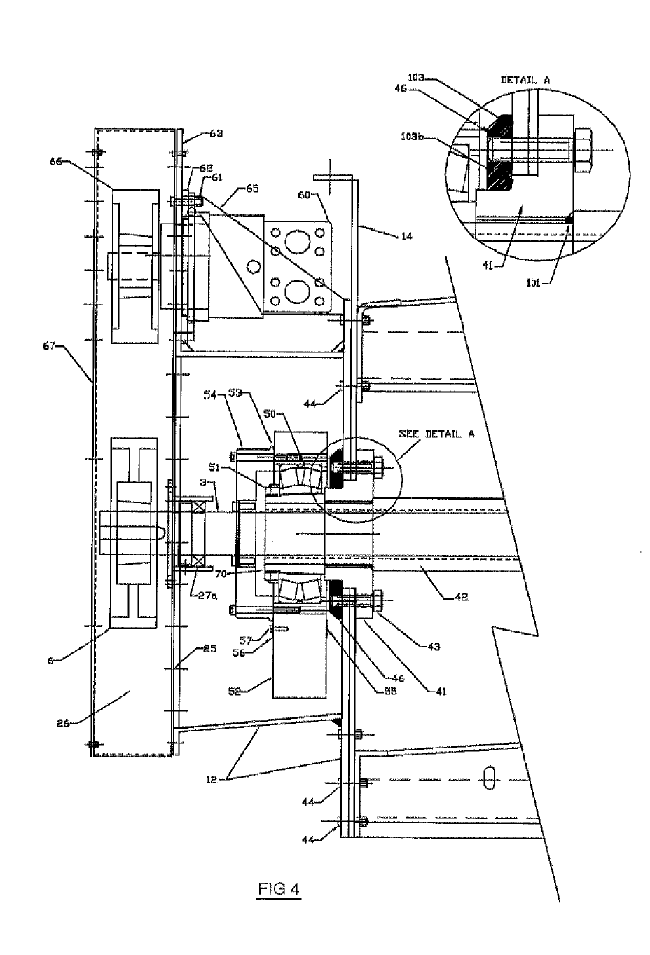

FIG. 4 is an enlarged view of FIG. 2 showing the drive side of the vibrating assembly;

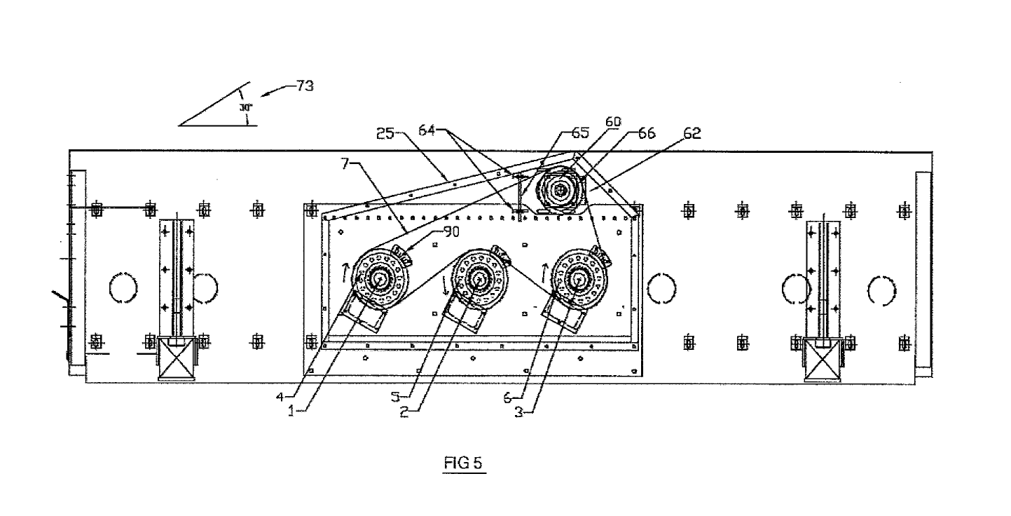

FIG. 5 is a side view of the apparatus of FIG. 1 with the cover of the timing belt compartment removed;

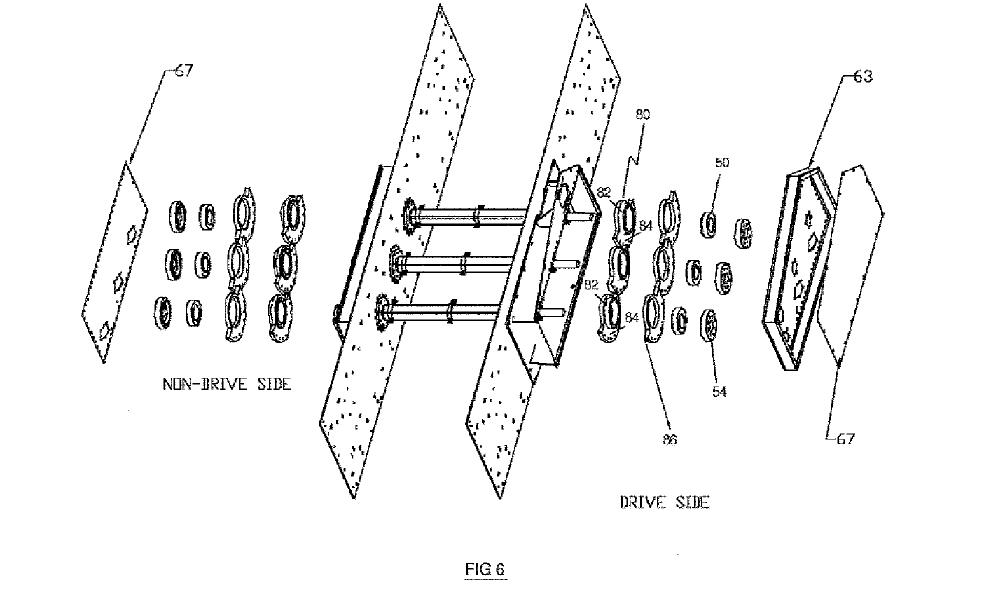

FIG. 6 is an exploded view of a screening apparatus incorporating a vibrating assembly according to a second embodiment of the Invention;

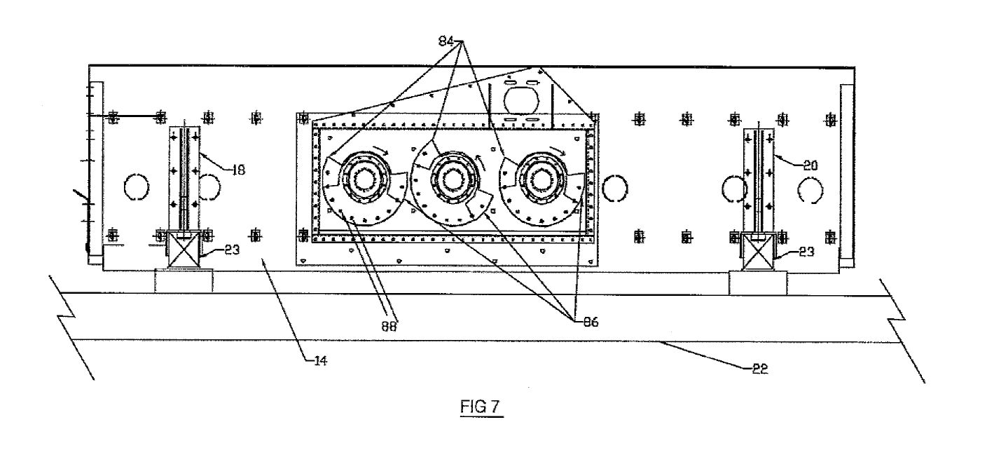

FIG. 7 is a side view of the apparatus of FIG. 6 with the main housing cover of the vibrating assembly removed;

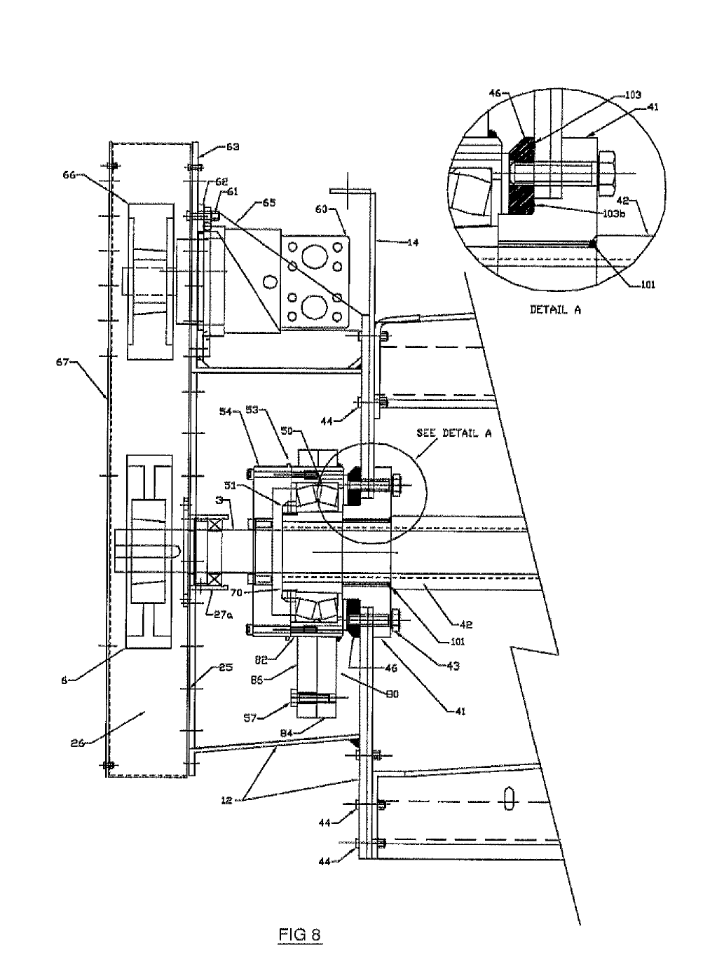

FIG. 8 is an enlarged cross-sectional and view of the apparatus of FIG. 6 showing the drive side of the vibrating assembly; and

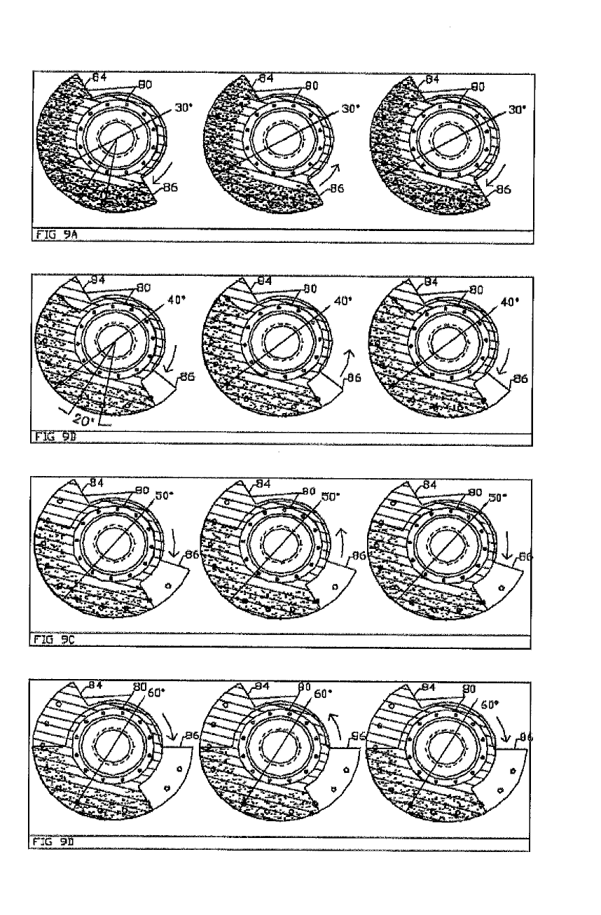

FIGS. 9a to 9d show the counter-weight and bearing housing of the vibrating assembly of FIG. 6 offset at four different angles.

Referring to the drawings and initially to FIGS. 1 to 5, a screening apparatus incorporating a first embodiment of a vibrating assembly according to the invention is shown. The vibrating assembly 100 comprises two sub-assemblies 10, 11 located on either side of the apparatus with three shafts 1, 2, 3 extending between the sub-assemblies 10 and 11. The vibrating assembly 100 is mounted on a subframe 22 using rubber or coil springs 23 and spring mountings 18, 19, 20, 21, thereby facilitating vibration of the assembly 100. The screening apparatus Illustrated is a two-deck screen box with screening media 27 held taut over screening decks 16, 17. The screening media 27 may be in a side tension configuration or in an in tension configuration for any embodiment of the invention. Both sub-assemblies 10, 11 have an identical set of components for each shaft except on the drive side of the vibrating assembly, where shafts 1, 2, 3 extend out through a main housing cover 25 into a timing belt compartment 26. Sub-assembly housings 12, 13 are secured to the screen box side plates 14, 15 using bolts. As each shaft 1, 2, 3 is identical, only shaft 3 as shown In FIGS. 2 and 4 is described.

Shaft 3 extends between the vibrating sub-assemblies 10, 11 through a shaft housing 40 which comprises a shaft tube 42 and two shaft coupling members 41 Inserted onto and secured towards the ends of the shaft tube 42. As the shaft coupling members 41 are an interference fit on the shaft tube 42, they can be welded in place using welds without risk of misalignment. Preferably, the shaft coupling members 41 can be secured to the shaft tube 42 by providing complimentary screw threads (not shown) on the ends of the shaft tube 42 and on the shaft coupling members 41. As shown in Detail A of FIG. 4 an O-ring seal 101 is mounted between the support housing 41 and the shaft tube 42. As shown in FIG. 4, sub-assembly housing 12 is secured to the shaft coupling member 41 with an Interference fit and by bolts 43 which pass through the screen box side plate 14 and the sub-assembly housing 12, and are secured to a fixing and sealing plate 46. The fixing and sealing plate 46 helps to secure the shaft coupling member 41 to the backing plate of the sub-assembly housing 12 and prevent oil leaking from the housing 12. For this purpose, the fixing and sealing plate 46 includes recesses for receiving O-ring seals 103 and 103b. O-ring seal 103 provides a seal between fixing and sealing plate 46 and the backing plate of the sub-assembly housing 12. O-ring seal 103b provides a seal between fixing and sealing plate 46 and shaft coupling member 41. Bolts 44 are also placed through the housing 12, the side plate 14 and the screening decks 16, 17.
A hub lock assembly 53 is detachably secured to the shaft 3 and Is rotatable about the shaft housing 42. The hub lock assembly 53 comprises an outer hub 54, a counter-weight 52 and a tapered adapter sleeve 70. The counter-weight 52 houses a self aligning bearing 50 which is mounted to the shaft housing 42 by means of the adapter sleeve 70, The self aligning bearing 50 is tightened onto the adapter sleeve 70 using nuts 51 and the adapter sleeve 70 is detachably fixed to the shaft housing 42. In use, the counterweight 52 rotates along with the shaft 3 causing vibration of the vibrating assembly 100 which is transmitted to the backing plate of the sub assembly housing 12 and on to the screening decks 16, 17 of the screening box. Plug weights (not shown) can be inserted through holes 59 in the counterweight 52 (FIG. 3). A weight Increase has the effect of increasing the stroke of vibration applied to the screen box.
As mentioned previously, the shaft 3 extends through the main housing cover 25 into a timing belt compartment 26 on the drive side of the vibrating assembly 100. A seal 27a is provided on the shaft 3 at the main housing cover 25 to prevent oil leaking into the timing belt compartment 26. A timing pulley 6 is locked in place on the end of the shaft 3 using a keyed taper lock (not shown).
A drive motor 60 is mounted on a sub-plate 62 and secured using bolts 61 through slots (not shown) on a plate 63. As shown in FIG. 5, the sub-plate 62 is additionally held in place by bolts 64 secured through a gusset 65. A drive pulley 66 is mounted on the motor 60 with a taper lock. A cover 67 is provided over the timing belt compartment 26 to create a dust free environment.
FIG. 5 shows a side view of the sub-assembly 10 with the cover 67 removed, The three shafts 1, 2, 3 and the corresponding timing pulleys 4, 6, 6 are shown. The motor 60 and drive pulley 66 are located above shaft 3. A timing belt 7 is arranged over the pulleys 4, 5, 6, 66 so that shafts 1 and 3 turn in a clockwise direction and shaft 2 turns in an anti-clockwise direction giving the vibration assembly 100 an oval vibration action. The pulley configuration shown ensures maximum belt wrap while maintaining a short slack on the belt 7 between drive pulley 66 and timing pulley 6. Belt flapping Is also minimized as the portion of the belt 7 between the drive pulley 66 and timing pulley 4 is taut and approximately at the same angle as the angle of vibration 73 which is typically for example 30 degrees and can be viewed on timing decal 90.
In a variation of the vibration assembly of the invention, the shafts are driven by an externally mounted motor. A shaft extending through drive pulley 60 and cover 67 is connected to an externally mounted motor by a chain or belt.
Referring now to FIGS. 6, 7, 8 and 9, a second embodiment of a vibrating assembly according to the invention is shown. FIGS. 7 and 8 correspond substantially to FIGS. 3 and 4 of the first embodiment and like numerals are used to denote like features in the two embodiments, The hub lock assembly 53 comprises e bearing housing 80, a counter-weight 86 and an outer hub 54. Hub lock assembly 53 further Includes a tapered adapter sleeve 70 (not shown in FIG. 6) as described previously for the first embodiment. As shown in FIG. 8, the bearing housing 80 comprises a cylindrical hub portion 82 and a counter-weight portion 84. The counter-weight portion 84 is substantially semi-circular in shape and is fixedly secured to the cylindrical hub portion 82. The cylindrical hub portion 82 houses a bearing 50 and counter-weight 80 engages over the cylindrical hub portion 82 and against the counter-weight portion 84 of the bearing housing 80.
Both the counter-weight portion 84 of the bearing housing 80 and the counter-weight 86 include a number of holes 88 through which bolts 57 are received. The bearing housing 80 and the counter-weight 80 are moveable relative to each other. An angular offset is achieved between the bearing housing 80 and the counter-weight 86 by removing bolts 57, moving the bearing housing 80 and the counter-weight 86 in opposite directions relative to each other and re-securing bolts 57 through corresponding holes 88.
In use, the counter-weight 86 and bearing housing 80 rotate along with the shaft 3 causing vibration of the assembly which is transmitted to the backing plate of the sub-assembly housing 12 as described previously for the first embodiment. The remaining parts of the vibrating assembly operate in the same manner as described previously for the first embodiment. Having an offset between the bearing housing 80 and the counter-weight 86 allows the angle and stroke of vibration to be changed to meet the needs of a given screening operation. The hub lock assembly 53 according to the second embodiment has the advantage that It makes the vibrating assembly easy to set up. Both the angle and stroke of vibration can be easily changed by rotating the counter-weight 86 and the counter-weight portion 84 of the bearing housing 80 relative to each other. Various examples of possible angular offsets between the counter-weight portion 84 of the hearing housing 60 and the counter weight 86 are depicted in FIGS. 9a to 9d with the shaded area corresponding to the counter-weight effect. FIG. 9a shows the counterweight portion 84 and the counter weight 86 in alignment giving a screening angle of 30° and a high stroke. FIG. 9b shows the counterweight portion 84 and the counter weight 86 overlapping to give a screening angle of 40° and a medium/high stroke. FIG. 9c shows the counterweight portion 64 and the counter weight 86 overlapping to give a screening angle of 50° and a medium stroke. FIG. 9d shows the counterweight portion 84 and the counter weight 86 overlapping to give a screening angle of 60° and a low stroke.
The vibrating assembly of the invention is not confined to a three shaft arrangement and can equally be employed in a one or two shaft arrangement. Also, only two screening decks 16, 17 are shown In the drawings. The invention can be utilized with screening apparatus having only one or more than two screening decks.
The present invention offers many advantages over existing vibrating assemblies namely,

Simplified design which is faster to manufacture with much reduced labour costs.

Lower parts cost which are symmetrical and can easily be machined on CNC machine.

Improved serviceability due to simple design and the use of the same parts on both sides.

Longer bearing life as lubrication oil in an oil bath at the base of the sub assembly housings cannot become contaminated with gear or sprocket filings when wear occurs.

Lower power consumption required because heavy gearwheels do not exist.

Timing can be changed easily by loosing the motor to slacken the timing belt 7 and then rotating shaft 1 or 3 to transfer the slack to shaft 2. The timing can then be changed by rotating shaft 2 to slip the belt a number of teeth forward or back. Each tooth is equal to 5 degrees. Round bars are fixed in position directly under shaft 1 and shaft 3 to stop the belt disengaging during, the timing process. Changes in timing can easily be seen on the timing decal 90 that covers the 3 shafts.

Timing changes can be made simply without entering the oil bath. Only the belt cover needs to be removed.

Longer screen life as timing bell and pulleys can be changed whereas when there is a wear problem with the gear type screen it is too costly to replace all the gears.

Simple to assemble as shafts do not have to be accurately aligned using the off centre hub which is required on the geared system.

Securing the tube inside the machined hubs has a number of advantages.

1. Self aligns the hub on the tube.

2. Add strength to assembly while maintaining simplicity.

3. Hubs are symmetrical and can be produced on CNC lathe at low cost.

4. Transfers the load directly to the backing plate of the oil bath without reliance on flanges or bolts.

5. From this backing plate the load is transferred to the screen decks and the screen sides.

6. Backing plate acts to locate the hub/tube assemblies.

Outer cover over belt provides extra protection to oil seals on shafts and will help to reduce dust or moisture from penetrating the oil bath.

Because the motor drive is incorporated into the timing belt assembly there is no requirement for an additional external drive belt.

This timing belt and motor arrangement also eliminates the requirement for jockey pulleys to ensure clearance and sufficient wrap on the pulleys.

Belt arranged so that long free length of belt is in line with angle of vibration and hence is not going to cause a belt flapping problem.

Increased strength as load is transferred directly from hubs to the backing plate and spread over a large area that covers the centre portion of the two decks.

It is to be understood that the invention is not limited to the specific details herein described, which are given by way of example only, and that various alterations and modifications are possible without departing from the scope of the invention as defined in the appended claims.

1. A screening apparatus having a screening box movably mounted on a support means via biasing means, the screening box comprising a pair of opposing side walls and a vibrating means for vibrating the screening box relative to the support means, the vibrating means comprising means for housing three rotatable shafts and means for coupling the shaft housing means to the opposing side walls of the screening box, each shaft rotatably housed in the at least one shaft housing means, the vibrating means further comprising a throw generating means rotatably mounted on both ends of each shaft housing means, the throw generating means being releasably fixed to each shaft, drive means mounted on a drive side of the apparatus and comprising a motor, shaft driver means on one end of each shaft and a flexible endless drive member coupled between the motor and the shaft driver means, each throw generating means being rotatable about the shaft housing means via the drive means and shafts to impart vibratory movement to the screening box, the flexible endless drive member positively engaging a drive member provided on the motor and the shaft driver means of each shaft, wherein the flexible endless drive member is housed in a compartment which is adjacent to and abuts a separate compartment housing the throw generating means on the drive side of the screening apparatus.

2. A screening apparatus as claimed in claim 1, wherein the shafts are mounted on the screen box at substantially the same vertical height.

3. A screening apparatus as claimed in claim 1, wherein the motor is located above the one or more shafts.

4. A screening apparatus as claimed in claim 1, wherein the flexible endless drive member is arranged over the shaft driver means of the three shafts and drive member so that end shafts turn in a clockwise direction and middle shaft turns in an anti-clockwise direction giving the vibration means an oval vibration action.

5. A screening apparatus as claimed in claim 1, wherein the portion of the flexible endless drive member between the drive member of the motor and one end shaft driver means is inclined at approximately the same angle as the angle of vibration of the screening box.

6. A screening apparatus as claimed in claim 1, wherein each shaft driver means is a pulley.

7. A screening apparatus as claimed in claim 1, wherein drive member is a pulley.

8. A screening apparatus as claimed in claim 1, wherein the flexible endless drive member is a belt.

9. A screening apparatus as claimed in claim 9, wherein the belt is double sided and has equally spaced teeth on both sides.

10. A screening apparatus as claimed in claim 1, wherein each throw generating means is a hub lock assembly comprising a self aligning bearing and a counterweight.

11. A screening apparatus as claimed in claim 10, wherein each hub lock assembly further comprises a tapered adapter sleeve mounted intermediate the shaft housing means and the self aligning bearing.

12. A screening apparatus as claimed in claim 10, wherein the counterweight has two component parts movable relative to one another for modifying the angle and stroke of vibration of the screening box.

13. A screening apparatus as claimed in claim 12, wherein the two component part counterweight has a first part comprising a cylindrical hub portion and a counterweight portion and a second part comprising a counter-weight engaging over the cylindrical hub portion and against the counter-weight portion.

14. A screening apparatus as claimed in claim 13, wherein the counter-weight portion and the counterweight each define a number of bolt receiving bores which are in alignment at particular relative angular positions of the counter-weight portion and the counter-weight.

15. A screening apparatus as claimed in claim 14, wherein bolts are located in the bolt receiving bores which are in alignment to fix the counter-weight portion and the counter-weight at particular relative angular positions.

16. A screening apparatus as claimed in claim 15, wherein the cylindrical hub portion houses the self aligning bearing.

17. A screening apparatus as claimed in claim 10, wherein the counterweight has a plurality of holes for receiving plug weights.

18. A screening apparatus as claimed in claim 1, wherein the shaft coupling means are secured towards the ends of the shaft housing means by forming complementary screw threads on the shaft coupling means and the shaft housing means.

19. screening apparatus as claimed in claim 1, wherein a fixing and sealing plate incorporates a first and second seal, wherein the first seal provides a seal between the fixing and sealing plate and a backing plate of the sub-assembly housing and wherein the second seal provides a seal between the fixing and sealing plate and shaft coupling means.

20. A screening apparatus as claimed in claim 1, wherein respective sealing means are provided on the main housing cover of a shaft and between a support housing and the shaft housing means to prevent the ingress of foreign particles into the flexible endless drive member compartment and the throw generating means compartment.
